(19) United States
(12) Patent Application Publication
(10) Pub. No.: US 2023/0311223 A1
(43) Pub. Date: Oct. 5, 2023

(54) METHOD FOR DRESSING A MULTIPLE THREAD GRINDING WORM

(71) Applicant: KAPP NILES GMBH & CO. KG, Coburg (DE)

(72) Inventor: Sergiy GRINKO, Coburg (DE)

(21) Appl. No.: 18/122,886

(22) Filed: Mar. 17, 2023

(30) Foreign Application Priority Data
Apr. 4, 2022 (DE) 10 2022 108 041.2

(51) Int. Cl. B23F 23/12

(52) U.S. Cl. CPC B23F 23/1225

(57) ABSTRACT

A method for dressing a multiple thread grinding worm by a dressing tool, in which the abrasive surfaces of the individual threads of the grinding worm are successively profiled with the dressing tool. The dressing is carried out in at least two threads with different dressing parameters so that the profiling of the abrasive surfaces of the threads differ from each other. The dressing parameters are selected so that the abrasive surfaces of at least two threads, viewed in the direction of the helix of the thread, differ from one another, and/or that the abrasive surfaces of the individual threads are profiled by topological dressing. A plurality of linear dressing strokes are performed over the height of the abrasive surface. The dressing tool is guided in the radial direction of the grinding worm at predetermined distances. The distances are constant in each thread but differing in at least two threads.

### CROSS-REFERENCE TO RELATED APPLICATIONS

The present application claims priority of DE 10 2022 108 041.2, filed Apr. 4, 2022, the priority of this application is hereby claimed, and this application is incorporated herein by reference.

### BACKGROUND OF THE INVENTION

The invention relates to a method for dressing a multiple thread grinding worm by means of a dressing tool, in which the abrasive surfaces of the individual threads of the grinding worm are successively profiled with the dressing tool, wherein the dressing is carried out in at least two threads with different dressing parameters so that the profiling of the abrasive surfaces of the threads differ from each other.

The grinding in particular of gears by means of generating grinding is well known. Grinding worms are used here, which usually have several parallel worm threads. In order to ensure that the geometry of the teeth of the gear to be ground is precise and lies within a specified tolerance, the grinding worm must be re-dressed both before it is used and after a certain number of ground workpieces. This often involves passing a rotating dressing roller through the individual worm threads one after the other, thus profiling the abrasive surface of the worm threads according to the specifications.

In practice, the multiple thread grinding worm is dressed at a specific path speed of the worm or a specific speed of the dressing roller, i.e. the rotational speed of the grinding worm and the rotational speed of the dressing roller during the dressing process are predefined. In topological dressing (where the profile is dressed line by line over the tooth height, thus also called “line dressing”), dressing can be performed with a topological or radius roller, wherein the ratio of number of threads and the degree of overlap (radial spacing of the individual dressing strokes) being used as the relevant dressing parameters.

DE 10 2011 115 526 A1 discloses a generic method. Here, in order to achieve an improved grinding overlap during topological dressing, the dressing tool is radially offset from thread to thread during dressing of the individual threads of the grinding worm, whereby the radial infeed is always the same in each thread during dressing line by line.

From WO 2022/028871 A1 it is known to dress a grinding worm with two different areas for roughing and for finishing a toothing in the two areas with different dressing parameters. However, for each working area, i.e. once for the roughing area and once for the finishing area, identical dressing parameters are provided in each worm thread.

To the state of the art known insofar, reference is made to FIG. 1, where a grinding worm 1 can be seen which is dressed with a dressing tool 2 in the form of a dressing roller, i.e. the abrasive surface 3 in the individual threads 4, 5 and 6 of the grinding worm are profiled with the same dressing parameters. Each of the three worm threads 4, 5 and 6 thus has the same periodic topography, which is accordingly reproduced on the gear flank of the gear to be ground after grinding.

FIG. 2 illustrates that in the three worm threads 4, 5 and 6, the ratio between the rotational speed n_{R} of the dressing roller 2 and the rotational speed n_{S} of the grinding worm 1 is the same in each case, forming periodically repeating segments around the circumference of the worm threads.

Exemplary here is the ratio between the two mentioned rotational speeds n_{R}/n_{S}=18, i.e. the dressing roller 2 rotates 18 times as fast as the grinding worm 1. Accordingly, the shape applied by the dressing roller to the abrasive surface 3 repeats every 20°.

If topological dressing is used, several dressing strokes are performed line by line in the radial direction r; the distance between two successive dressing strokes is indicated by x, as can be seen in FIG. 3 for the previously known procedure. During topological dressing, therefore, grooves are formed on the shell surface (i.e. on the abrasive surface) of the worm threads, which run parallel to the thread unwinding. The distance between the grooves in the direction of the thread height is always the same and thus also the topography of each thread.

The topography produced in this way forms on the gear flank in a corresponding manner and can cause uneven running during operation of the gear due to the periodicity. Such periodic structures are therefore undesirable for reasons of noise development during operation.

FIGS. 2 and 3 show a schematic view of the abrasive surface as seen from the front of the grinding worm.

Thus, in the aforementioned generic process, all threads of the grinding worm are profiled with the same dressing parameters.

It has become known from DE 199 05 136 B4 that the rotational speeds between the dressing roller and the grinding worm can be changed during the dressing process, whereby the change is stochastic. This is intended to prevent regular patterns. However, here, too, the machining of all worm threads is carried out according to this method and is therefore the same.

DE 10 2018 126 259 A1 shows a similar solution, whereby a regular pattern is also to be prevented during dressing. For this purpose, a relative additional movement is provided in addition to a non-constant rotational speed. Here, too, all worm threads are profiled according to this method and thus in the same way.

### SUMMARY OF THE INVENTION

The invention is based on the object of further developing a generic process in such a way that it is possible to achieve a further improved grinding result for the workpiece without sacrificing economic efficiency. In particular, it should be possible to manufacture gears that are characterized by smoother running.

The solution of this object by the invention provides that the dressing parameters are selected in such a way that the abrasive surfaces of at least two threads, viewed in the direction of the helix of the thread, differ from one another, and/or that the abrasive surfaces of the individual threads are profiled by topological dressing, wherein a plurality of linear dressing strokes are performed over the height of the abrasive surface, in which the dressing tool is guided in the radial direction of the grinding worm at predetermined distances, wherein the distances are constant in each thread but differing in at least two threads (preferably in all threads). In the latter case it is preferably provided that the distances between at least two threads differ by at least 5%, preferably by at least 10% and particularly preferably by at least 15%.

Preferably, dressing is performed in all threads with different dressing parameters; thus, the profiling of the abrasive surfaces differs in all threads.

According to one embodiment of the invention, it may be provided here that the grinding worm rotates at a rotational speed during the dressing process, wherein the rotational speed of the grinding worm differs in at least two threads (preferably in all threads) during dressing of the abrasive surfaces of a thread.

The dressing tool may also be a dressing roller that rotates at a rotational speed during the dressing process, wherein the rotational speed of the dressing roller differs in at least two threads (preferably in all threads) when dressing the abrasive surfaces of a thread.

A particularly preferred embodiment is to select the dressing parameters in such a way that the abrasive surfaces of at least two threads, viewed in the direction of the helix of the thread, differ from each other, so that the grinding worm rotates at a rotational speed during the dressing process and the dressing tool is a dressing roller which rotates at a rotational speed during the dressing process, wherein the ratio of the rotational speeds during dressing of the abrasive surfaces of one thread is constant but differs in at least two threads (preferably in all threads). In the latter case, the ratio of the rotational speed of the grinding worm and the rotational speed of the dressing roller differs between at least two threads preferably by at least 5%, preferably by at least 10%, and particularly preferably by at least 15%.

Regarding the mentioned direction of the helix of the worm thread, it should be noted that this is to be understood as the direction of the helix of the worm thread or the longitudinal flank direction of the worm thread, when moving in the direction of the helix of the worm thread. Along this path, according to the invention, the abrasive surfaces in at least two (preferably in all) worm threads differ as a result of the choice of dressing parameters.

According to another embodiment of the invention it is provided that the grinding worm rotates during the dressing process and the dressing tool is a dressing roller which rotates during the dressing process, wherein the dressing is performed in one thread in synchronism of grinding worm and dressing roller (grinding worm and dressing roller rotate in the same direction) and the dressing is performed in at least one other thread in counter-rotation of grinding worm and dressing roller (grinding worm and dressing roller rotate in opposite directions).

Of course, it can also be provided that the individual measures above, with which the different dressing parameters in the individual threads of the grinding worm are realized, are used in combination. Accordingly, the change in the rotational speed of the grinding worm, the change in the rotational speed of the dressing roller, the change in the ratio of the rotational speeds of the grinding worm and dressing roller, the change in the different radial distances during topological dressing and the use of synchronous/counter-rotation can be carried out in any combination.

A possible dressing device for a multiple thread grinding worm comprises a reception and a rotary drive for the grinding worm to be dressed and a reception and preferably a rotary drive for a dressing tool, wherein control or feed-back control means are provided by which the dressing parameters, in particular the rotational speed of the grinding worm and/or the rotational speed of the dressing tool being a dressing roller, can be specified differently in at least two threads (preferably in all threads) during dressing of the abrasive surfaces of the threads of the grinding worm.

Furthermore, a software program for determining dressing parameters for dressing of a multiple thread grinding worm with a dressing tool for carrying out the proposed method can be provided, which, after presetting dressing parameters for dressing the grinding worm, determines different dressing parameters for the various threads of the grinding worm and presets them to a machine control system.

The proposed concept is therefore based on variable dressing of the individual threads of a multiple thread grinding worm. Within a single thread, the dressing parameters remain the same, but the parameters differ from thread to thread.

As far as the different parameters are concerned, the primary idea is to change the rotational speeds of the grinding worm and/or a dressing roller, whereby in particular the ratio of said rotational speeds changes from worm thread to worm thread. Furthermore, different path speeds (speed at which the dressing tool is guided relative to the abrasive surface of the grinding worm to be dressed) can be provided between the individual worm threads.

If dressing is performed topologically, it is possible to work with different degrees of overlap (distances in radial direction between the individual dressing strokes).

Especially when grinding gears, this can improve the smooth running of the gear during operation.

With the proposed approach, the periodicity of the topography of the abrasive surface in the worm threads and thus the topography of the tooth flanks of the workpiece after grinding is positively influenced, so that feed marks can be eliminated; this leads to smoother running of the gears in the gearbox.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a perspective view of a multiple thread grinding worm which is dressed by a dressing roller,

FIG. 2 shows schematically for three threads of the grinding worm the procedure for dressing according to the state of the art,

FIG. 3 shows schematically for three threads of the grinding worm the procedure for topological dressing according to the state of the art,

FIG. 4 shows schematically for three threads of the grinding worm the procedure for dressing according to an embodiment of the invention, and

FIG. 5 shows schematically the procedure for topological dressing according to another embodiment of the invention for three threads of the grinding worm.

### DETAILED DESCRIPTION OF THE INVENTION

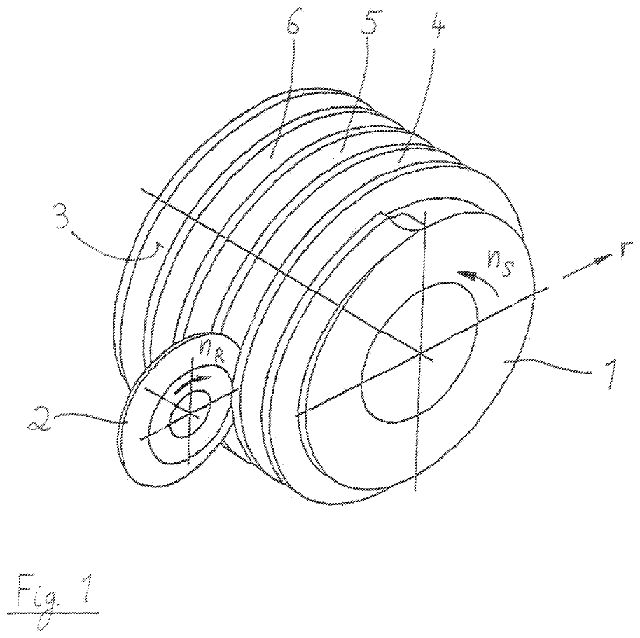

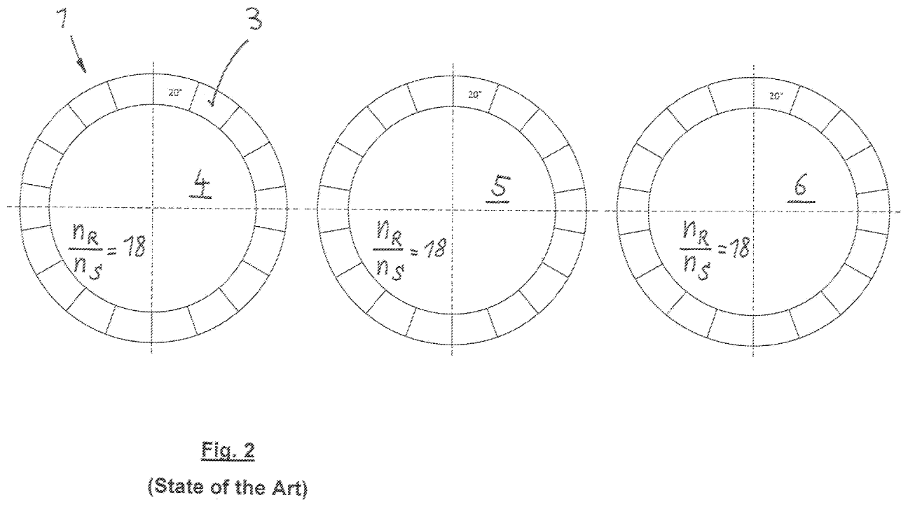

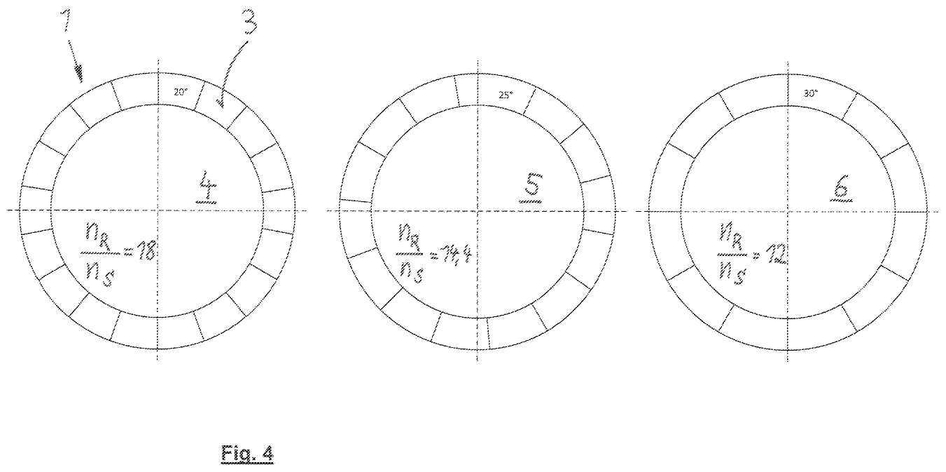

FIG. 4 shows an example of an embodiment of the invention analogous to FIG. 2. The abrasive surface 3, which was profiled by means of the dressing roller 2, is shown schematically for three worm threads 4, 5 and 6 of the grinding worm 1 (see FIG. 1). It can be seen that the ratio of the rotational speed n_{R} of the dressing roller to the rotational speed n_{S} of the grinding worm is different in the three worm threads. In the first worm thread 4, said ratio n_{R}/n_{S} is 18, in the second worm thread 5 it is 14.4, and in the third worm thread 6 it is 12. Accordingly, different profiling results in the three worm threads 4, 5, and 6, since dressing was performed with different dressing parameters in the different threads.

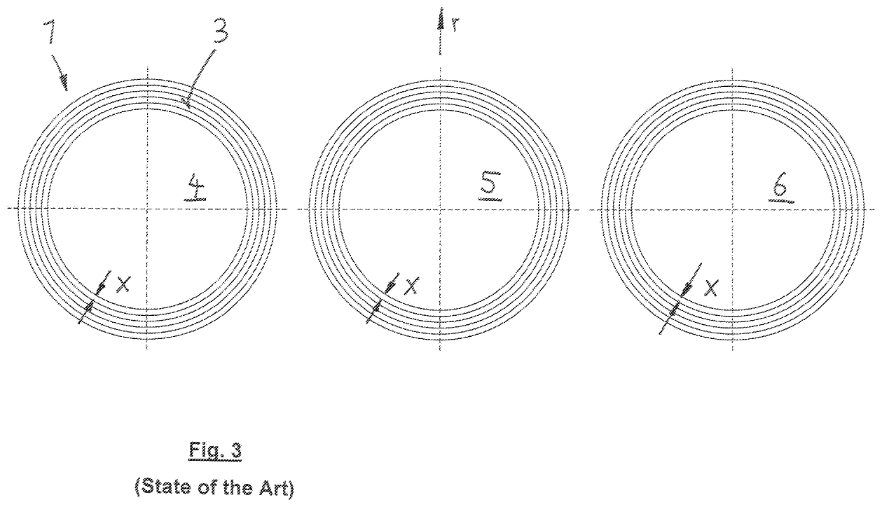

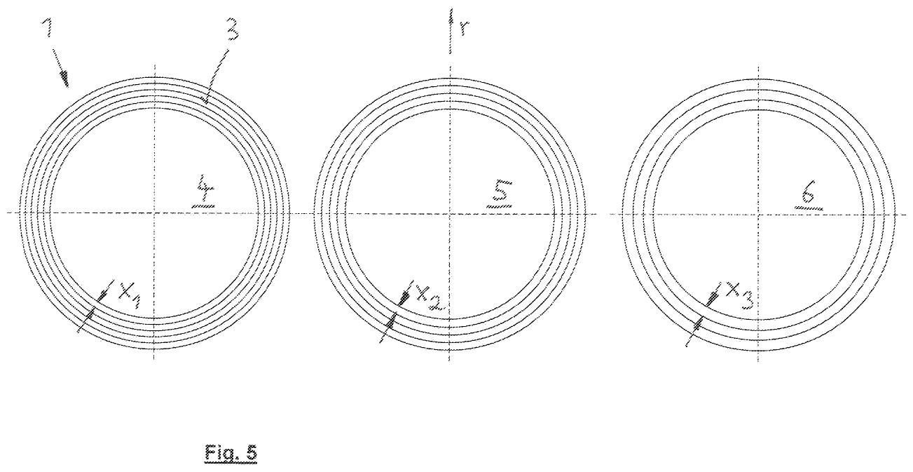

In FIG. 5, analogous to FIG. 3, another embodiment of the invention is shown, whereby here the abrasive surface 3 was profiled by means of topological dressing. As can be seen from the three illustrations in FIG. 5 for the worm threads 4, 5 and 6, a different value was selected for the distance x (measured in the radial direction r of the grinding worm 1) of the individual linear dressing strokes in each case, so that the coverage of the profiling is different in the individual threads.

The proposed concept is therefore based on the fact that during dressing (in particular with a conventional combination dressing roller or with a flexible dressing roller) the rotational speed of the dressing tool and/or the rotational speed of the grinding tool or the path speed is selected differently in each thread of the worm, so that different dressing parameters are present. Thus, the impressions of the dressing roller and thus the topography on the shell surface of each worm thread will be different.

If the number of threads of the grinding worm and the number of teeth of the workpiece are not divisible by an integer (which corresponds to the intended and thus most frequent machining case), all the threads of the grinding worm are used in succession in a tooth space of the workpiece. Since all the worm threads have a different topography, the generation of the surface on the tooth flank becomes less periodic and more variable, especially in the flank line direction.

In a very advantageous way, the proposed process does not have any negative effect on productivity, since the desired changes (i.e. the change of dressing parameters) are only specified differently by the machine control.

In topological dressing (see FIG. 5), the degree of overlap is selected differently in each thread of the worm. As in the case of conventional dressing, the differences in tool topography are reflected in each thread, which is then reflected on the tooth flanks of the workpiece after grinding. However, in this case, the variability of the surface created in this way is more in the flank profile direction (i.e. it changes in the radial direction r).

The changed rotational speed ratio n_{R}/n_{S} or the changed distance x (i.e., the degree of overlap) need not, of course, be varied in descending order from thread to thread, as illustrated in FIGS. 4 and 5. An ascending trend or an entirely variable design can also be provided.

The change in dressing parameters from thread to thread is preferably varied in such a way that the best result is achieved with regard to the smooth running of the gear teeth.

Thereby, it is also possible that some threads of the grinding worm are machined with the same parameters and only one thread or several other threads are profiled with the changed dressing parameters.

While specific embodiments of the invention have been shown and described in detail to illustrate the inventive principles, it will be understood that the invention may be embodied otherwise without departing from such principles.

I claim:

1. A method for dressing a multiple thread grinding worm by means of a dressing tool, in which the abrasive surfaces of the individual threads of the grinding worm are successively profiled with the dressing tool, wherein the dressing is carried out in at least two threads with different dressing parameters so that the profiling of the abrasive surfaces of the threads differ from each other, wherein the dressing parameters are selected in such a way that the abrasive surfaces of at least two threads, viewed in the direction of the helix of the thread, differ from one another,
and/or
that the abrasive surfaces of the individual threads are profiled by topological dressing, wherein a plurality of linear dressing strokes are performed over the height of the abrasive surface, in which the dressing tool is guided in the radial direction of the grinding worm at predetermined distances, wherein the distances are constant in each thread but differing in at least two threads.

2. The method according to claim 1, wherein the dressing is carried out with different dressing parameters in all threads.

3. The method according to claim 1, wherein the grinding worm rotates at a rotational speed during the dressing process, wherein the rotational speed of the grinding worm during dressing of the abrasive surfaces of a thread differs in at least two threads.

4. The method according to claim 1, wherein the dressing tool is a dressing roller rotating at a rotational speed during the dressing process, wherein the rotational speed of the dressing roller during dressing of the abrasive surfaces of a thread differs in at least two threads.

5. The method according to claim 1, wherein the grinding worm rotates at a rotational speed during the dressing process and the dressing tool is a dressing roller which rotates at a rotational speed during the dressing process, wherein the ratio of the rotational speeds is constant during dressing of the abrasive surfaces of a thread, but differs in at least two threads.

6. The method according to claim 5, wherein the ratio of the rotational speed of the grinding worm and the rotational speed of the dressing roller differs between at least two threads by at least 5%, preferably by at least 10% and particularly preferably by at least 15%.

7. The method according to claim 1, wherein the distances between at least two threads differ by at least 5%, preferably by at least 10% and particularly preferably by at least 15%.

8. The method according to claim 1, wherein the grinding worm rotates during the dressing process and the dressing tool is a dressing roller which rotates during the dressing process, wherein the dressing is performed in one thread in synchronism of grinding worm and dressing roller and the dressing is performed in at least one other thread in counter-rotation of grinding worm and dressing roller.
